(19) United States
(12) Patent Application Publication
(10) Pub. No.: US 2024/0203034 A1
(43) Pub. Date: Jun. 20, 2024

(54) BOX SPLITTING FOR BOUNDING VOLUME HIERARCHIES

(71) Applicants: Advanced Micro Devices, Inc., Santa Clara, CA (US); ATI Technologies ULC, Markham (CA)

(72) Inventors: David William John Pankratz, Markham (CA); David Kirk McAllister, Santa Clara, CA (US); Daniel James Skinner, Milton Keynes (GB); Michael John Livesley, Milton Keynes (GB); David Ronald Oldcorn, Milton Keynes (GB)

(73) Assignees: Advanced Micro Devices, Inc., Santa Clara, CA (US); ATI Technologies ULC, Markham (CA)

(21) Appl. No.: 18/081,422

(22) Filed: Dec. 14, 2022

(51) Int. Cl. G06T 15/06

(52) U.S. Cl. CPC G06T 15/06; G06T 2210/12

(57) ABSTRACT

A technique for performing ray tracing operations is provided. The technique includes, testing a plurality of bounding boxes for intersection with a ray in parallel, wherein the plurality of bounding boxes are specified by a plurality of box data items of a parent box node of a bounding volume hierarchy; determining that, for a first child node that is pointed to by a two or more node pointers specified by two or more box data items of the plurality of box data items, at least one bounding box specified by the two or more box data items is intersected by the ray; and in response to the determining, traversing to the first child node.

### BACKGROUND

Ray tracing is a type of graphics rendering technique in which simulated rays of light are cast to test for object intersection and pixels are colored based on the result of the ray cast. Ray tracing is computationally more expensive than rasterization-based techniques, but produces more physically accurate results. Improvements in ray tracing operations are constantly being made.

### BRIEF DESCRIPTION OF THE DRAWINGS

A more detailed understanding may be had from the following description, given by way of example in conjunction with the accompanying drawings wherein:

FIG. 1 is a block diagram of an example device in which one or more features of the disclosure can be implemented;

FIG. 2 is a block diagram of the device, illustrating additional details related to execution of processing tasks on the accelerated processing device of FIG. 1, according to an example;

FIG. 3 illustrates a ray tracing pipeline for rendering graphics using a ray tracing technique, according to an example;

FIG. 4 is an illustration of a bounding volume hierarchy, according to an example;

FIG. 5 illustrates a portion of a bounding volume hierarchy, according to an example;

FIG. 6 illustrates details of a box data item, according to an example;

FIG. 7 illustrates geometry associated with a box data item of the bounding volume hierarchy of FIG. 5, according to an example;

FIG. 8 illustrates a portion of a bounding volume hierarchy in which two box data items point to the same box node, according to an example;

FIG. 9 illustrates bounding box geometry corresponding to the portion of the bounding volume hierarchy of FIG. 8;

FIG. 10 illustrates an example technique for modifying a bounding volume hierarchy, according to an example; and

FIG. 11 is a flow diagram of a method for traversing a bounding volume hierarchy, according to an example.

### DETAILED DESCRIPTION

A technique for performing ray tracing operations is provided. The technique includes, testing a plurality of bounding boxes for intersection with a ray in parallel, wherein the plurality of bounding boxes are specified by a plurality of box data items of a parent box node of a bounding volume hierarchy; determining that, for a first child node that is pointed to by a two or more node pointers specified by two or more box data items of the plurality of box data items, at least one bounding box specified by the two or more box data items is intersected by the ray; and in response to the determining, traversing to the first child node.

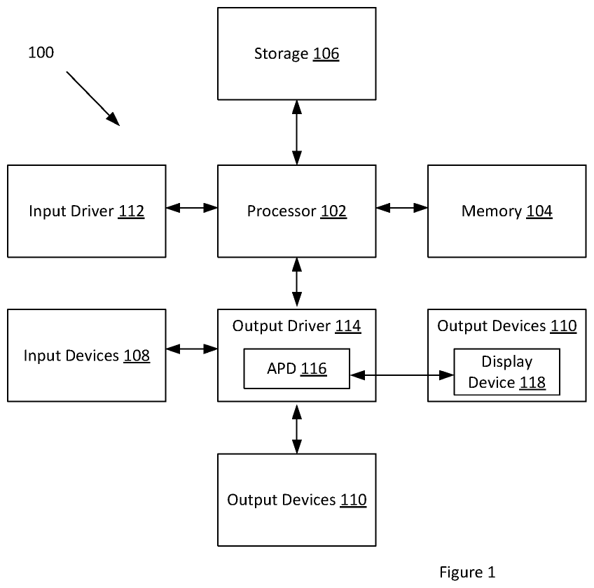

FIG. 1 is a block diagram of an example device 100 in which one or more features of the disclosure can be implemented. The device 100 includes, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 also optionally includes an input driver 112 and an output driver 114. It is understood that the device 100 includes additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display device 118, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 114 includes an accelerated processing device (“APD”) 116 which is coupled to a display device 118. The APD 116 is configured to accept compute commands and graphics rendering commands from processor 102, to process those compute and graphics rendering commands, and to provide pixel output to display device 118 for display. As described in further detail below, the APD 116 includes one or more parallel processing units configured to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and configured to provide (graphical) output to a display device 118. For example, it is contemplated that any processing system that performs processing tasks in accordance with a SIMD paradigm can be configured to perform the functionality described herein. Alternatively, it is contemplated that computing systems that do not perform processing tasks in accordance with a SIMD paradigm performs the functionality described herein.

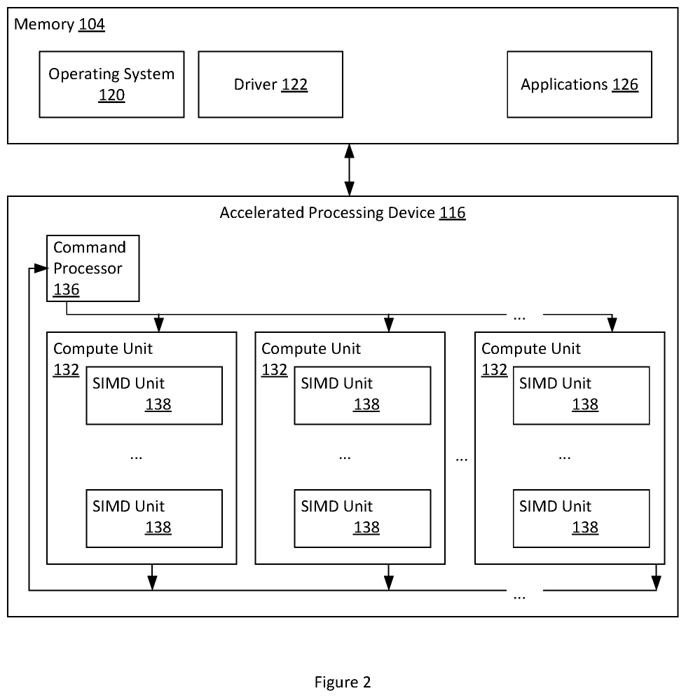

FIG. 2 is a block diagram of the device 100, illustrating additional details related to execution of processing tasks on the APD 116. The processor 102 maintains, in system memory 104, one or more control logic modules for execution by the processor 102. The control logic modules include an operating system 120, a driver 122, and applications 126. These control logic modules control various features of the operation of the processor 102 and the APD 116. For example, the operating system 120 directly communicates with hardware and provides an interface to the hardware for other software executing on the processor 102. The driver 122 controls operation of the APD 116 by, for example, providing an application programming interface (“API”) to software (e.g., applications 126) executing on the processor 102 to access various functionality of the APD 116. In some implementations, the driver 122 includes a just-in-time compiler that compiles programs for execution by processing components (such as the SIMD units 138 discussed in further detail below) of the APD 116. In other implementations, no just-in-time compiler is used to compile the programs, and a normal application compiler compiles shader programs for execution on the APD 116.

The APD 116 executes commands and programs for selected functions, such as graphics operations and non-graphics operations that are suited for parallel processing and/or non-ordered processing. The APD 116 is used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 (together, parallel processing units 202) that include one or more SIMD units 138 that perform operations at the request of the processor 102 in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but executes that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow. In an implementation, each of the compute units 132 can have a local L1 cache. In an implementation, multiple compute units 132 share a L2 cache.

The basic unit of execution in compute units 132 is a work-item. Each work-item represents a single instantiation of a program that is to be executed in parallel in a particular lane. Work-items can be executed simultaneously as a “wavefront” on a single SIMD processing unit 138. One or more wavefronts are included in a “work group,” which includes a collection of work-items designated to execute the same program. A work group is executed by executing each of the wavefronts that make up the work group. In alternatives, the wavefronts are executed sequentially on a single SIMD unit 138 or partially or fully in parallel on different SIMD units 138. Wavefronts can be thought of as the largest collection of work-items that can be executed simultaneously on a single SIMD unit 138. Thus, if commands received from the processor 102 indicate that a particular program is to be parallelized to such a degree that the program cannot execute on a single SIMD unit 138 simultaneously, then that program is broken up into wavefronts which are parallelized on two or more SIMD units 138 or serialized on the same SIMD unit 138 (or both parallelized and serialized as needed). A scheduler 136 is configured to perform operations related to scheduling various wavefronts on different compute units 132 and SIMD units 138.

The parallelism afforded by the compute units 132 is suitable for graphics related operations such as pixel value calculations, vertex transformations, and other graphics operations. Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

The compute units 132 implement ray tracing, which is a technique that renders a 3D scene by testing for intersection between simulated light rays and objects in a scene. Much of the work involved in ray tracing is performed by programmable shader programs, executed on the SIMD units 138 in the compute units 132, as described in additional detail below.

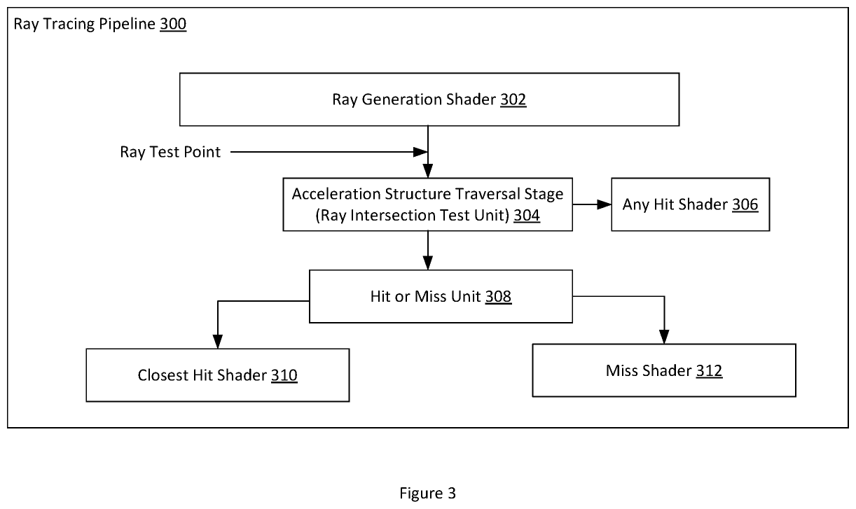

FIG. 3 illustrates a ray tracing pipeline 300 for rendering graphics using a ray tracing technique, according to an example. The ray tracing pipeline 300 provides an overview of operations and entities involved in rendering a scene utilizing ray tracing. A ray generation shader 302, any hit shader 306, closest hit shader 310, and miss shader 312 are shader-implemented stages that represent ray tracing pipeline stages whose functionality is performed by shader programs executing in the SIMD unit 138. Any of the specific shader programs at each particular shader-implemented stage are defined by application-provided code (i.e., by code provided by an application developer that is pre-compiled by an application compiler and/or compiled by the driver 122). The acceleration structure traversal stage 304 performs a ray intersection test to determine whether a ray hits a triangle.

The various programmable shader stages (ray generation shader 302, any hit shader 306, closest hit shader 310, miss shader 312) are implemented as shader programs that execute on the SIMD units 138. The acceleration structure traversal stage 304 is implemented in software (e.g., as a shader program executing on the SIMD units 138), in hardware, or as a combination of hardware and software. The hit or miss unit 308 is implemented in any technically feasible manner, such as as part of any of the other units, implemented as a hardware accelerated structure, or implemented as a shader program executing on the SIMD units 138. The ray tracing pipeline 300 may be orchestrated partially or fully in software or partially or fully in hardware, and may be orchestrated by the processor 102, the scheduler 136, by a combination thereof, or partially or fully by any other hardware and/or software unit. The term “ray tracing pipeline processor” used herein refers to a processor executing software to perform the operations of the ray tracing pipeline 300, hardware circuitry hard-wired to perform the operations of the ray tracing pipeline 300, or a combination of hardware and software that together perform the operations of the ray tracing pipeline 300.

The ray tracing pipeline 300 operates in the following manner. A ray generation shader 302 is executed. The ray generation shader 302 sets up data for a ray to test against a triangle and requests the acceleration structure traversal stage 304 test the ray for intersection with triangles.

The acceleration structure traversal stage 304 traverses an acceleration structure, which is a data structure that describes a scene volume and objects (such as triangles) within the scene, and tests the ray against triangles in the scene. In various examples, the acceleration structure is a bounding volume hierarchy. The hit or miss unit 308, which, in some implementations, is part of the acceleration structure traversal stage 304, determines whether the results of the acceleration structure traversal stage 304 (which may include raw data such as barycentric coordinates and a potential time to hit) actually indicates a hit. For non-opaque triangles that are hit, the ray tracing pipeline 300 may trigger execution of an any hit shader 306. Note that multiple triangles can be hit by a single ray. It is not guaranteed that the acceleration structure traversal stage will traverse the acceleration structure in the order from closest-to-ray-origin to farthest-from-ray-origin. The hit or miss unit 308 triggers execution of a closest hit shader 310 for the triangle closest to the origin of the ray that the ray hits, or, if no triangles were hit, triggers a miss shader.

Note, it is possible for the any hit shader 306 to “reject” a hit from the ray intersection test unit 304, and thus the hit or miss unit 308 triggers execution of the miss shader 312 if no hits are found or accepted by the ray intersection test unit 304. An example circumstance in which an any hit shader 306 may “reject” a hit is when at least a portion of a triangle that the ray intersection test unit 304 reports as being hit is fully transparent. Because the ray intersection test unit 304 only tests geometry, and not transparency, the any hit shader 306 that is invoked due to a hit on a triangle having at least some transparency may determine that the reported hit is actually not a hit due to “hitting” on a transparent portion of the triangle. A typical use for the closest hit shader 310 is to color a material based on a texture for the material. A typical use for the miss shader 312 is to color a pixel with a color set by a skybox. It should be understood that the shader programs defined for the closest hit shader 310 and miss shader 312 may implement a wide variety of techniques for coloring pixels and/or performing other operations.

A typical way in which ray generation shaders 302 generate rays is with a technique referred to as backwards ray tracing. In backwards ray tracing, the ray generation shader 302 generates a ray having an origin at the point of the camera. The point at which the ray intersects a plane defined to correspond to the screen defines the pixel on the screen whose color the ray is being used to determine. If the ray hits an object, that pixel is colored based on the closest hit shader 310. If the ray does not hit an object, the pixel is colored based on the miss shader 312. Multiple rays may be cast per pixel, with the final color of the pixel being determined by some combination of the colors determined for each of the rays of the pixel.

It is possible for the closest hit shader 310 or the miss shader 312, to spawn their own rays, which enter the ray tracing pipeline 300 at the ray test point. These rays can be used for any purpose. One common use is to implement environmental lighting or reflections. In an example, when a closest hit shader 310 is invoked, the closest hit shader 310 spawns rays in various directions. For each object, or a light, hit by the spawned rays, the closest hit shader 310 adds the lighting intensity and color to the pixel corresponding to the closest hit shader 310. It should be understood that although some examples of ways in which the various components of the ray tracing pipeline 300 can be used to render a scene have been described, any of a wide variety of techniques may alternatively be used.

As described above, the determination of whether a ray hits an object is referred to herein as a “ray intersection test.” The ray intersection test involves shooting a ray from an origin and determining whether the ray hits a triangle and, if so, what distance from the origin the triangle hit is at. For efficiency, the ray tracing test uses a representation of space referred to as a bounding volume hierarchy. This bounding volume hierarchy is the “acceleration structure” described above. In a bounding volume hierarchy, each non-leaf node represents an axis aligned bounding box that bounds the geometry of all children of that node. In an example, the base node represents the maximal extents of an entire region for which the ray intersection test is being performed. In this example, the base node has two children that each represent mutually exclusive axis aligned bounding boxes that subdivide the entire region. Each of those two children has two child nodes that represent axis aligned bounding boxes that subdivide the space of their parent, and so on. Leaf nodes represent a triangle against which a ray test can be performed. It should be understood that where a first node points to a second node, the first node is considered to be the parent of the second node.

The bounding volume hierarchy data structure allows the number of ray-triangle intersections (which are complex and thus expensive in terms of processing resources) to be reduced as compared with a scenario in which no such data structure were used and therefore all triangles in a scene would have to be tested against the ray. Specifically, if a ray does not intersect a particular bounding box, and that bounding box bounds a large number of triangles, then all triangles in that box can be eliminated from the test. Thus, a ray intersection test is performed as a sequence of tests of the ray against axis-aligned bounding boxes, followed by tests against triangles.

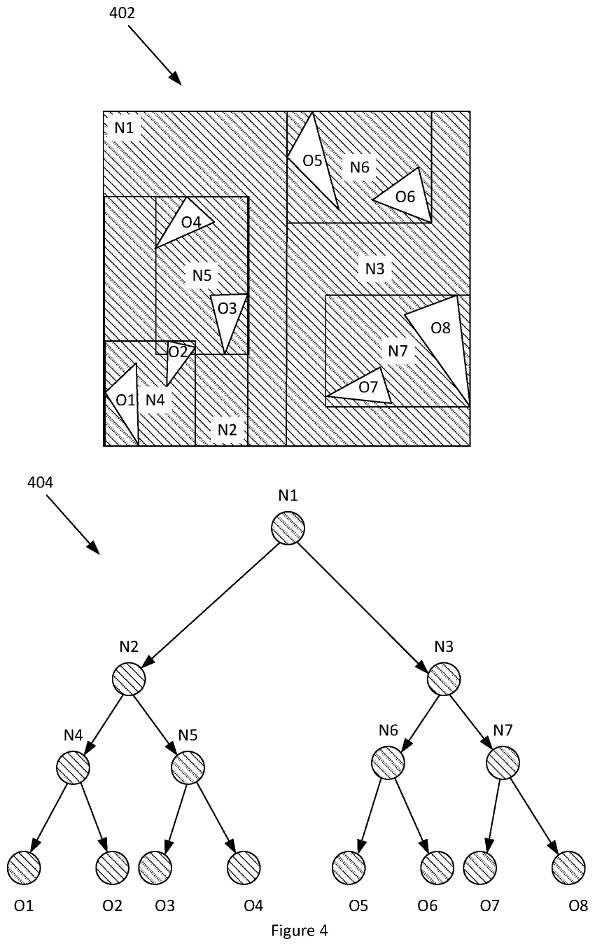

FIG. 4 is an illustration of a bounding volume hierarchy, according to an example. For simplicity, the hierarchy is shown in 2D. However, extension to 3D is simple, and it should be understood that the tests described herein would generally be performed in three dimensions.

The spatial representation 402 of the bounding volume hierarchy is illustrated in the left side of FIG. 4 and the tree representation 404 of the bounding volume hierarchy is illustrated in the right side of FIG. 4. The non-leaf nodes are represented with the letter “N” and the leaf nodes are represented with the letter “O” in both the spatial representation 402 and the tree representation 404. A ray intersection test would be performed by traversing through the tree 404, and, for each non-leaf node tested, eliminating branches below that node if the box test for that non-leaf node fails. For leaf nodes that are not eliminated, a ray-triangle intersection test is performed to determine whether the ray intersects the triangle at that leaf node.

In an example, the ray intersects O₅ but no other triangle. The test would test against N₁, determining that that test succeeds. In this example, the test would test against N₂, determining that the test fails. The test would eliminate all sub-nodes of N₂ and would test against Ng, noting that that test succeeds. The test would test N₆ and N₇, noting that N₆ succeeds but N₇ fails. The test would test O₅ and O₆, noting that O₅ succeeds but O₆ fails. Instead of testing 8 triangle tests, two triangle tests (O₅ and O₆) and five box tests (N₁, N₂, N₃, N₆, and N₇) are performed. Note that rays can have a variety of directions and can have an origin in a variety of locations. Thus, the specific boxes eliminated or not eliminated would depend on the origin and direction of the rays. However, in general, testing the rays for intersection with boxes eliminates some leaf nodes from consideration.

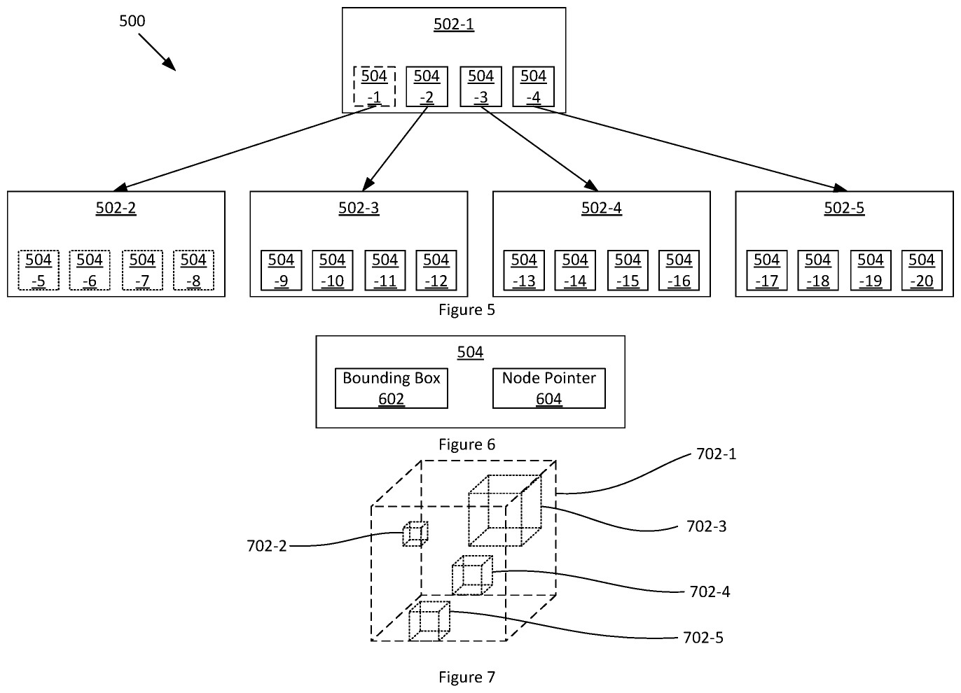

FIG. 5 illustrates a portion of a bounding volume hierarchy 500, according to an example. The portion of the bounding volume hierarchy 500 that is illustrated includes a number of box nodes 502. Each box node 502 includes box data items 504. As shown in FIG. 6, each box data item 504 includes a bounding box 602 and a node pointer 604. The node pointer 604 points to another node 502 and the bounding box 602 specifies a bounding box that tightly bounds the geometry of the pointed to node 502 (that is, the triangle(s) and/or bounding boxes of the pointed-to node 502 and children thereof). This configuration allows traversal of the bounding volume hierarchy 500 to occur by iteratively processing nodes 502 of the bounding volume hierarchy 500. Processing a box node in this manner includes testing the bounding boxes 602 of the box data items 504 of the box node for intersection with a ray. For each bounding box 602 intersected by the ray, the ray tracing pipeline 300 traverses to the box node 502 pointed to by the corresponding node pointer 604 (e.g., the node pointer in the same box data item 504 as the bounding box 602 determined to be intersected by the ray).

FIG. 7 illustrates geometry associated with a box data item 504-1 of the bounding volume hierarchy 500 of FIG. 5. A bounding box 702-1 is the bounding box 602 specified in the box data item 504-1. During traversal of the BVH 500, the ray tracing pipeline 300 tests the ray for intersection against this bounding box 702-1 and, if the ray intersects the bounding box 702-1, traverses to the bounding box 502-2 via the node pointer 604 of the box data item 504-1.

This child bounding box 502-2, in turn, includes multiple box data items 504, each of which includes an associated bounding box 602 and a node pointer 604. Bounding box 702-2 is associated with box data item 504-5, bounding box 702-3 is associated with box data item 504-6, bounding box 702-4 is associated with box data item 504-7, and bounding box 702-4 is associated with box data item 504-8. It can be seen that bounding box 702-1 bounds all the other illustrated bounding boxes 702, which is in line with the fact that box node 502-1 is the parent of box node 502-2, which contains the box data items 504 corresponding to those bounding boxes (702-2 through 702-5).

There are several characteristics of the bounding volume hierarchy 500 that can result in inefficiencies. Bounding boxes specified by box data items 504 may include a large amount of empty geometric space. Traversal using bounding boxes with large amounts of empty space is inefficient because such traversal can result in a large amount of false positives, which results in additional unnecessary work. For example, a ray that intersects a parent bounding box but does not intersect any child of the parent bounding box requires that the ray be tested against each such child to make the determination that the ray does not intersect any child. The large amount of empty space represents a large amount of opportunity for such false positives to occur. Better fitting bounding boxes with less empty space represent a significantly more efficient traversal.

In addition to the issue of geometrically empty space, it is also possible for box nodes 502 to have unoccupied space where box node data 504 should be. More specifically, box nodes 502 are all generally of fixed size, selected from one or from a small number of possible box node sizes. This fixed size means that there is space in each box node 502 for a particular number of box data items 504, such as 4 or 8. It is possible, however, for a BVH builder to build a BVH in such a way that it is not possible to fill all box data items 504 of all box nodes 502. In other words, it is sometimes the case that box nodes 502 are not fully utilized. Downsides of not fully utilizing box nodes 502 includes inefficient use of storage and bandwidth, as well as inefficient processing of box nodes. In particular, in some implementations, the box data items 504 of a box node are processed in parallel (e.g., in a SIMD manner). In an example, a SIMD unit 138 processes a box node 502 by fetching the box data items 504 of that box node, where each box data item 504 is fetched by a different work-item executing on the SIMD unit 138. Each work-item tests the corresponding bounding box for intersection by the ray. If a box data item 504 is empty, the corresponding work-item performs no useful work, which results in a decrease in total work done.

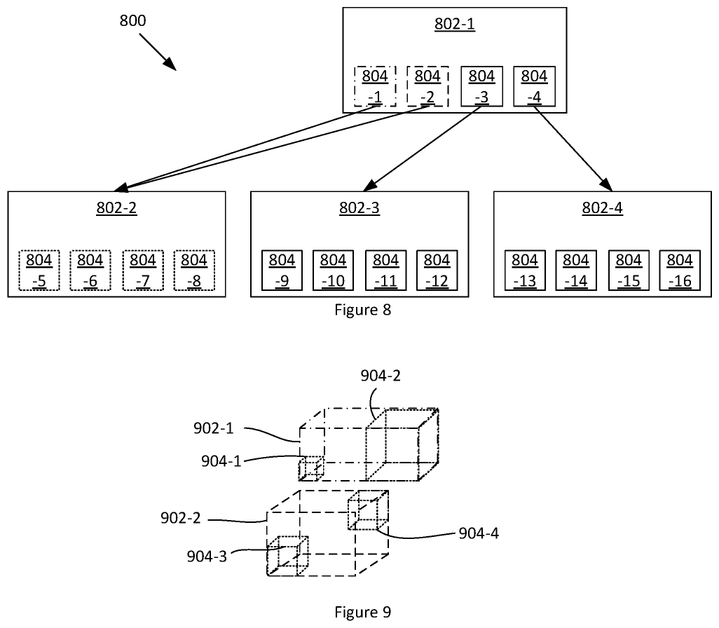

The present disclosure provides techniques for alleviating some of the difficulties described above. The techniques involve a bounding volume hierarchy in which multiple box data items of a box node are permitted to point to the same box node. FIGS. 8 and 9 illustrate this technique.

FIG. 8 illustrates a portion of a bounding volume hierarchy 800 in which two box data items 804 point to the same box node 802-2, according to an example. FIG. 9 illustrates corresponding bounding box geometry. FIGS. 8 and 9 are now described together.

In FIG. 8, box nodes 802 are illustrated and include box data items 804. The box nodes 802 are similar to the box nodes 502 of FIG. 5. One difference between box nodes 802 and box nodes 502 is that box nodes 802 can include multiple box data items 804 that point to the same other box node 802 (i.e., to the same child). Thus, any particular box data item 804 is able to point to the same box node 802 as another box data item 804.

Another difference is that each box node 802 is able to contain box data items associated with geometry that is bounded by multiple bounding boxes, where in the system of FIG. 5, each box node 502 contains box data items bounded by a single bounding box. More specifically, in FIG. 5, a box data item defines the single bounding box (bounding box 602) that bounds all children of the box node 502 pointed to by the corresponding box data item 504. For example, box data item 504-1 includes a bounding box 602 and also a node pointer 604 that points to bounding box 502-2. The bounding box 602 bounds all children of bounding box 502-2.

By contrast, in FIG. 8, each box node 802 can include children bounded by multiple different bounding boxes 602 of different box data items 804. During traversal, the ray tracing pipeline 300 processes a box node 802 by testing the bounding boxes 602 of the box data items 804 of that box node 802 for intersection with a ray. If any of the bounding boxes 602 where the corresponding box node pointer 604 points to the same box node 802 are intersected by the ray, then the ray tracing pipeline 300 traverses to that box node 802. For example, if either (or both) of the bounding boxes 602 for box data item 804-1 or box data item 804-2 intersect the ray, then the ray tracing pipeline 300 traverses to box node 802-2.

In FIG. 9, bounding box 902-1 is the bounding box 602 specified by box data item 804-1 and bounding box 902-2 is the bounding box 602 specified by box data item 804-2. Bounding box 904-1 is the bounding box 602 specified by box data item 804-5 and bounding box 904-2 is the bounding box 602 specified by box data item 804-6. Bounding box 904-3 is the bounding box 602 specified by box data item 804-7 and bounding box 904-4 is the bounding box 602 specified by box data item 804-8. It can be seen that bounding box 902-1 bounds both bounding box 904-1 and bounding box 904-2 but not bounding box 904-3 or bounding box 904-4. Similarly, bounding box 902-2 bounds bounding box 904-3 and bounding box 904-4 but not bounding box 904-1 or bounding box 904-2. As can be seen, there are two bounding boxes that enclose the geometry of box node 802-2—bounding box 902-1 (box data item 804-1) and bounding box 902-2 (box data item 804-2).

In summary, in the configuration of FIGS. 5-7, each box data item 504 specifies a bounding box and a node pointer. The bounding box bounds all geometry of the box node specified by the node pointer 604. By contrast, in the configuration of FIGS. 8-9, it is possible that a box data item 804 has a bounding box that bounds less than all of the geometry of the box node pointed to by the corresponding node pointer 604. In addition, in the configuration of FIGS. 5-7, each box node can be thought of as being associated with a single bounding box (that is, the bounding box specified by the box data item that points to that box node). By contrast, in the configuration of FIGS. 8-9, each box node can be associated with one or more bounding boxes (that is, multiple different box nodes can specify different bounding boxes that bound different geometry of the same box node).

Although it is sometimes stated that the children of a box node are other box nodes, in some examples, one or more children of a box node is a triangle or a procedural primitive. In other words, the node pointer 604 of at least some box nodes points to a triangle. A procedural primitive is a primitive whose geometry is defined procedurally. As with the case where the children of a box nodes are other box nodes, in the implementation of FIGS. 8-9 a box data item can include a bounding box 602 that encloses some but not all of the triangle referenced by the node pointer 604 of that same box data item. In other words, in the implementation of FIGS. 8-9, it is possible for multiple box data items to point to the same triangle. In addition, in such instances, it is possible that one such box data item includes a bounding box that bounds a first portion of the triangle and not a second portion of the triangle and that another such data item includes a bounding box that bounds the second portion of the triangle and not the first portion of the triangle.

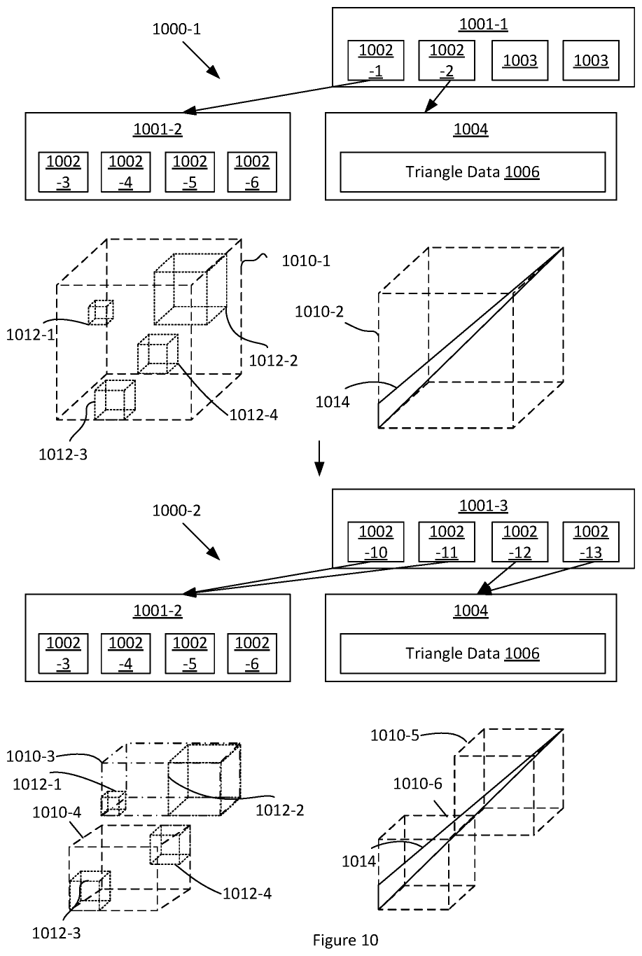

FIG. 10 illustrates an example technique for modifying a bounding volume hierarchy, according to an example. In this example, a BVH builder (which can be implemented as software executing on a processor, hardware including fixed function or programmable hardware, either of which includes circuitry, or a combination thereof) converts a first version of a BVH 1000-1 to a second version of the BVH 1000-2. In the first version of the BVH 1000-1, a box node 1001-1 includes two box data items 1002-1 and 1002-2 and two empty data items 1003. The empty data items 1003 are present because a BVH builder was unable to fill up the space allocated to the box node 1001-1 with data. This inability can occur for a variety of reasons and is dependent on the algorithm that the BVH builder uses to build the BVH. There are at least two issues with these empty data items 1003. First, empty data items 1003 represent wasted space and bandwidth. Specifically, the storage for the empty data items 1003 is allocated but not used. In addition, although data (e.g., garbage data) is transmitted for the empty data items 1003, that data is not used. Second, empty data items 1003 represented wasted processing power. Specifically, a SIMD processor 138 processes a box data item 1002 by determining whether a ray intersects each of the bounding boxes represented by the box data items 1002. If some of those box data items are empty, then the corresponding SIMD lanes are not utilized, which represents a processing inefficiency.

To alleviate the above issues, in response to a box node 1001 including one or more empty data items 1003, the bounding volume hierarchy builder “splits” one or more of the other box data items 1002. This split increases the number of box data items 1002 in the box node 1001. Splitting a box data item 1002 includes generating multiple new box data items 1002, where each new box data item 1002 includes a bounding box that bounds a subset of the children of the original box data item 1002. In some examples, each generated box data item 1002 points to the same child node as the original box data item 1002.

In FIG. 10, box data item 1002-1 corresponds to bounding box 1010-1. Box data items 1002-3, 1002-4, 1002-5, and 1002-6 correspond to bounding boxes 1012-1, 1012-2, 1012-3, and 1012-4, respectively. Box data item 1002-2 corresponds to box data item 1010-2. Triangle 1014 corresponds to triangle data 1006. As can be seen, the bounding box 1010-1 for box data item 1002-1 bounds all children of box node 1001-2. Additionally, the bounding box 1010-2 for box data item 1002-2 bounds the entirety of the triangle 1014, of node 1004.

The bounding volume hierarchy generator modifies the box node 1001-1 to generate modified box node 1001-3 in the following manner. The bounding volume hierarchy generator generates box data item 1002-10 and box data 1002-11 from box data item 1002-1. The bounding volume hierarchy generate also generates box data item 1002-12 and box data item 1002-13 from box data item 1002-2. As can be seen, there are no more empty box data nodes 1003.

Box data item 1002-10 includes bounding box 1010-3, which bounds bounding box 1012-1 and bounding box 1012-2, corresponding to box data item 1002-3 and box data item 1002-4. Box data item 1002-11 includes bounding box 1010-4, which bounds bonding box 1012-3 and bounding box 1012-4, corresponding to box data items 1002-5 and 1002-6.

For the triangle, box data item 1002-12 and box data item 1002-13 include bounding box 1010-5 and bounding box 1010-6, respectively. Each of these bounding boxes bounds a different portion of the triangle 1014.

By splitting the box data items 1002 of the box node, the bounding volume hierarchy generator improves the efficiency of processing by reducing the amount of empty space in bounding boxes, which reduces false positives. Further, this improvement is done at minimal cost because no additional storage space is used and no additional processing time is used.

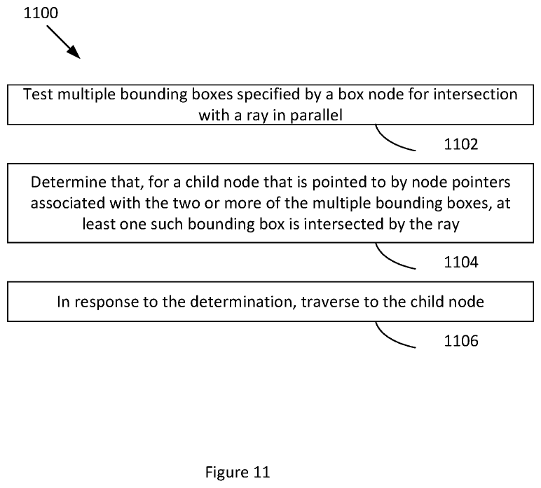

FIG. 11 is a flow diagram of a method 1100 for traversing a bounding volume hierarchy, according to an example. Although described with respect to the systems of FIGS. 1-10, those of skill in the art will understand that any system, configured to perform the steps of the method 1100 in any technically feasible order, falls within the scope of the present disclosure.

At step 1102, the ray tracing pipeline 300 processes a box node (e.g., box node 802). The box node includes multiple box data items, each of which includes a bounding box. At least two of the box data items include pointers that point to the same child node.

At step 1104, the ray tracing pipeline 300 determines that, for a child node that is pointed to by two or more of the box data item pointers, at least one corresponding bounding box is intersected by the ray. In response to that determination, at step 1106, the ray tracing pipeline traverses to the child node.

In addition to the above, as described elsewhere herein, in some implementations, a bounding volume hierarchy builder generates the bounding volume hierarchy include a box node with two box data item that point to the same child node, by modifying a bounding volume hierarchy with at least one empty box data item, as described with respect to FIG. 10. In various examples, the method 1100 incorporates any or all of the disclosure described elsewhere herein.

Note that although the present disclosure sometimes refers to triangles as being in the leaf nodes of the bounding volume hierarchy, any other geometric shape could alternatively be used in the leaf nodes. In such instances, compressed triangle blocks include two or more such primitives that share at least one vertex.

Each of the units illustrated in the figures represent hardware circuitry configured to perform the operations described herein, software configured to perform the operations described herein, or a combination of software and hardware configured to perform the steps described herein. For example, the ray tracing pipeline 300, ray generation shader 302, any hit shader 306, hit or miss unit 308, miss shader 312, closest hit shader 310, and acceleration structure traversal stage 304 are implemented fully in hardware, fully in software executing on processing units (such as compute units 132), or as a combination thereof. In some examples, the acceleration structure traversal stage 304 is partially implemented as hardware and partially as software. In some examples, the portion of the acceleration structure traversal stage 304 that traverses the bounding volume hierarchy is software executing on a processor and the portion of the acceleration structure traversal stage 304 that performs the ray-box intersection tests and ray-triangle intersection tests is implemented in hardware.

It should be understood that many variations are possible based on the disclosure herein. Although features and elements are described above in particular combinations, each feature or element can be used alone without the other features and elements or in various combinations with or without other features and elements.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements aspects of the embodiments.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for performing ray tracing operations, the method comprising:
testing a plurality of bounding boxes for intersection with a ray in parallel, wherein the plurality of bounding boxes are specified by a plurality of box data items of a parent box node of a bounding volume hierarchy;
determining that, for a first child node that is pointed to by a two or more node pointers specified by two or more box data items of the plurality of box data items, at least one bounding box specified by the two or more box data items is intersected by the ray; and
in response to the determining, traversing to the first child node.

2. The method of claim 1, wherein the two or more box data items specify two or more bounding boxes.

3. The method of claim 2, wherein geometry of a second child node of the first child node is bounded by a first bounding box of the two or more bounding boxes and the geometry of the second child node is not bounded by a second bounding box of the two or more bounding boxes.

4. The method of claim 1, wherein the first child node comprises a box node.

5. The method of claim 1, wherein the first child node comprises a triangle node or a node storing information for procedural primitive.

6. The method of claim 1, further comprising modifying an original version of the bounding volume hierarchy to generate the bounding volume hierarchy.

7. The method of claim 6, wherein an original version of the parent box node includes one or more empty box data items.

8. The method of claim 7, wherein modifying the original version of the bounding volume hierarchy includes splitting an original box data item of the original version of the parent box node in response to the original version of the parent box node include the one or more empty box data items.

9. The method of claim 8, wherein splitting the original box data item results in generating the two or more box data items, each of which includes a pointer that points to the first child node.

10. The method of claim 1, further comprising generating the bounding volume hierarchy without modifying an original version.

11. A system for performing ray tracing operations, the system comprising:
a memory configured to store a bounding volume hierarchy; and
a processor configured to perform operations including:
testing a plurality of bounding boxes for intersection with a ray in parallel, wherein the plurality of bounding boxes are specified by a plurality of box data items of a parent box node of the bounding volume hierarchy;
determining that, for a first child node that is pointed to by a two or more node pointers specified by two or more box data items of the plurality of box data items, at least one bounding box specified by the two or more box data items is intersected by the ray; and
in response to the determining, traversing to the first child node.

12. The system of claim 11, wherein the two or more box data items specify two or more bounding boxes.

13. The system of claim 12, wherein geometry of a second child node of the first child node is bounded by a first bounding box of the two or more bounding boxes and the geometry of the second child node is not bounded by a second bounding box of the two or more bounding boxes.

14. The system of claim 11, wherein the first child node comprises a box node.

15. The system of claim 11, wherein the first child node comprises a triangle node or a node storing information for procedural primitive.

16. The system of claim 11, further comprising modifying an original version of the bounding volume hierarchy to generate the bounding volume hierarchy.

17. The system of claim 16, wherein an original version of the parent box node includes one or more empty box data items.

18. The system of claim 17, wherein modifying the original version of the bounding volume hierarchy includes splitting an original box data item of the original version of the parent box node in response to the original version of the parent box node include the one or more empty box data items.

19. The system of claim 18, wherein splitting the original box data item results in generating the two or more box data items, each of which includes a pointer that points to the first child node.

20. A non-transitory computer-readable medium storing instructions that, when executed by a processor, cause the processor to perform operations comprising:
testing a plurality of bounding boxes for intersection with a ray in parallel, wherein the plurality of bounding boxes are specified by a plurality of box data items of a parent box node of a bounding volume hierarchy;
determining that, for a first child node that is pointed to by a two or more node pointers specified by two or more box data items of the plurality of box data items, at least one bounding box specified by the two or more box data items is intersected by the ray; and
in response to the determining, traversing to the first child node.
